(19) United States
(12) Patent Application Publication
(10) Pub. No.: US 2026/0029905 A1
(43) Pub. Date: Jan. 29, 2026

(54) METHOD, APPARATUS, DEVICE AND STORAGE MEDIUM OF INTERFACE INTERACTION

(71) Applicants: Beijing Zitiao Network Technology Co., Ltd., Beijing (CN); Lemon Inc., Grand Cayman (KY)

(72) Inventors: Linyi Zheng, Beijing (CN); Tianhao He, CULVER CITY, CA (US); Chenman Zhou, Beijing (CN); Isabel Rose Ringo, CULVER CITY, CA (US)

(21) Appl. No.: 19/277,696

(22) Filed: Jul. 23, 2025

(30) Foreign Application Priority Data
Jul. 23, 2024 (WO) PCT/CN2024/107125

(51) Int. Cl. G06F 3/04845; G06F 3/0482; G06F 3/04847

(52) U.S. Cl. CPC G06F 3/04845; G06F 3/0482; G06F 3/04847

(57) ABSTRACT

The embodiment of the invention relates to a method, apparatus, device and a storage medium of interface interaction. The provided method includes the following steps: displaying an image content of a content item in a first interface; moving the image content in the first interface based on a received interaction operation; in response to the interaction operation being maintained until a first trigger condition is satisfied, displaying, in the first interface, an interface indication element corresponding to a second interface; and in response to an end state of the interaction operation satisfying a second trigger condition, switching to display the second interface corresponding to the interface indication element. In this way, the embodiments of the present disclosure can improve the efficiency of interface switching.

### CROSS REFERENCE

This application claims the benefit of priority of PCT application No. PCT/CN2024/107125, filed on Jul. 23, 2024, entitled “Method, Apparatus, Device and Storage Medium of Interface Interaction”, which is incorporated herein by reference in its entirety.

### FIELD

Example embodiments of the present disclosure generally relate to the field of computers, and in particular, to a method, apparatus, device, and a computer-readable storage medium of interface interaction.

### BACKGROUND

In recent years, with the development of the Internet, more and more people view content of a content item in a network platform. For example, people utilize media platforms to view various media content items. However, when a user views a media content item in a traditional media platform, it is easy for the user to perform an incorrect operation based on a traditional manner for interaction operation, resulting in undesirable interface switching.

### SUMMARY

In a first aspect of the present disclosure, there is provided a method of interface interaction, comprising: displaying an image content of a content item in a first interface; moving the image content in the first interface based on a received interaction operation; in response to the interaction operation being maintained until a first trigger condition is satisfied, displaying, in the first interface, an interface indication element corresponding to a second interface; and in response to an end state of the interaction operation satisfying a second trigger condition, switching to display the second interface corresponding to the interface indication element.

In a second aspect of the present disclosure, an apparatus of interface interaction is provided. The apparatus comprises a first presentation module, configured to display an image content of a content item in a first interface; a processing module, configured to move the image content in the first interface based on a received interaction operation; a second presentation module, configured to, in response to the interaction operation being maintained until a first trigger condition is satisfied, display, in the first interface, an interface indication element corresponding to a second interface; and a switching module, configured to, in response to an end state of the interaction operation satisfying a second trigger condition, switch to display the second interface corresponding to the interface indication element.

In a third aspect of the present disclosure, an electronic device is provided. The device comprises at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in connection with the accompanying drawings. In the drawings, the same or similar reference numbers refer to the same or similar elements, wherein:

FIG. 1 illustrates a schematic diagram of an example environment in which some embodiments of the present disclosure can be implemented;

FIGS. 2A-2F illustrate example interfaces in accordance with some embodiments of the present disclosure;

FIGS. 3A-3D illustrate example interfaces according to some further embodiments of the present disclosure;

FIG. 4 shows a flowchart of an example process of interface interaction according to some embodiments of the present disclosure;

FIG. 5 illustrates a schematic structural block diagram of an example apparatus of interface interaction according to some embodiments of the present disclosure; and

FIG. 6 illustrates a block diagram of an electronic device capable of implementing a plurality of embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, collection, obtain, process, manufacture, forward and usage of all of the data, etc., all of which are performed on the premise that the user knows and confirms. Accordingly, when implementing the embodiments of the present disclosure, the types, the usage scope, the usage scenario, and the like of the data or information that may be involved, should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, the processing may be performed on the premise of having a legality basis (for example, obtaining consent of a personal information subject, or necessary for performing a fulfillment contract), and processing only within a specified or agreed range. The user's rejection of personal information other than necessary information required by the basic function will not affect the basic function of the user.

As briefly mentioned above, as the Internet develops, more and more people view content of a content item in a network platform. For example, people utilize media platforms to view various media content items. However, conventional solutions are prone to incorrect operation, resulting in undesirable interface switching.

Embodiments of the present disclosure provide a solution for interface interaction. According to the scheme, an image content of a content item may be displayed in a first interface; the target image content in the first interface may be moved based on a received interaction operation; in response to the interaction operation being maintained until a first trigger condition is satisfied, an interface indication element corresponding to a second interface may be displayed in the first interface; and in response to an end state of the interaction operation satisfying a second trigger condition, switching to display the second interface corresponding to the interface indication element.

In this way, the embodiments of the present disclosure can present the interface indication element for directing the user to switch the interface when the user interacts with the content item, thereby prompting the user to perform the switching between the interfaces and reducing the probability of incorrect operation. In this way, the embodiments of the present disclosure can provide more information elements for the user during the interaction operation, thereby improving the utilization rate of the information. Further, the present disclosure can improve the accuracy of interface switching and improve the user interaction experience based on the provided information elements.

Various example implementations of this scheme are described in detail below in conjunction with the accompanying drawings.

### Example Environment

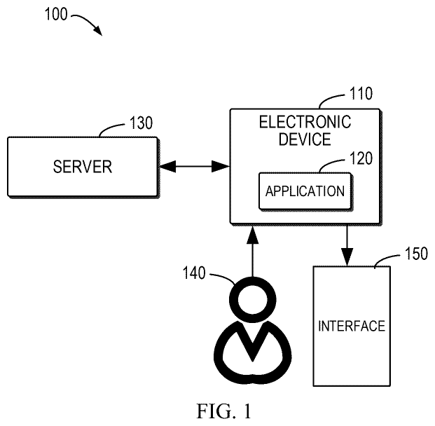

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. Application 120 may be any suitable type of application for interface interaction, examples of which may include, but are not limited to: a video application, a social application, or other suitable application. The user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

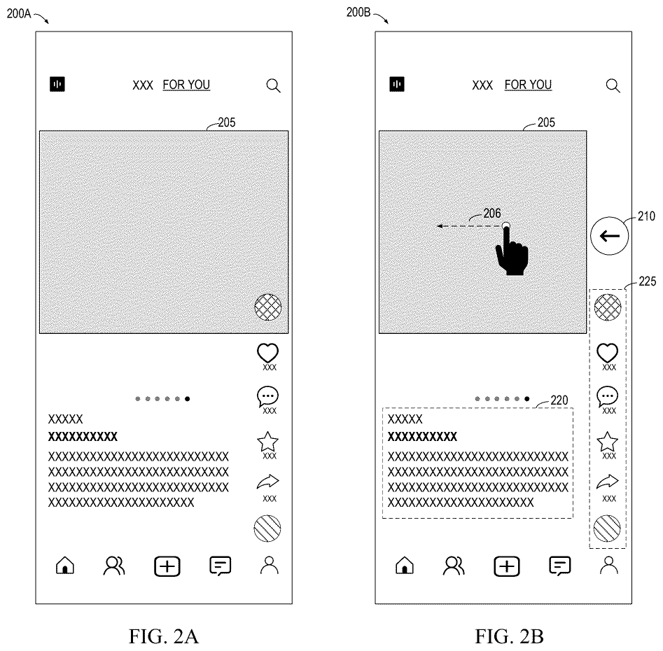

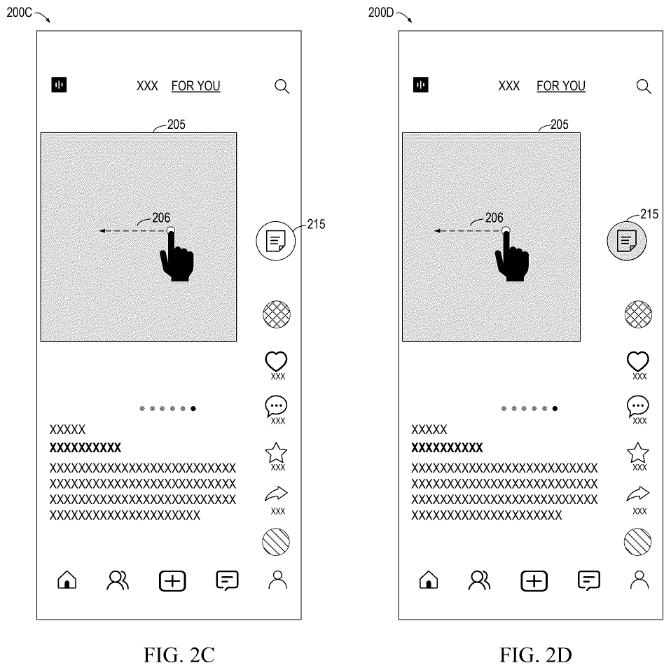

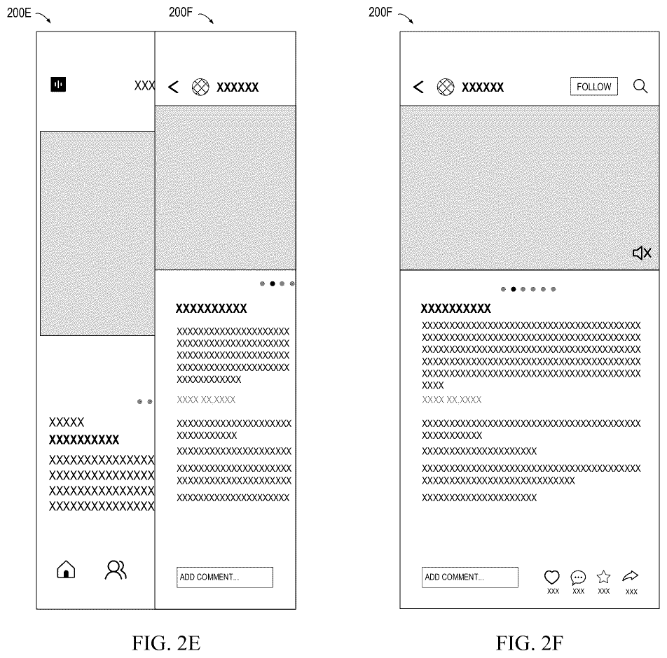

FIGS. 2A-2F illustrate example interfaces 200A-200F, in accordance with some embodiments of the present disclosure. The interface 200A to the interface 200F may be provided, for example, by the electronic device 110 shown in FIG. 1.

In some embodiments, as shown in FIG. 2A, the electronic device 110 may present the first interface 200A through the content item data downloaded from the server. The electronic device 110 may display the image content 205 of the content item (i.e., play the content item) in the first interface 200A. As an example, the type of the content item may be a video type, an image-text type, or the like. As an example, a content item may include, for example, a video or a plurality of images.

In some embodiments, as shown in FIG. 2B, the electronic device 110 moves the image content in the first interface 200B based on the received interaction operation (e.g., the direction indicated by the arrow 206 in FIG. 2B may indicate a moving direction of the image content).

In some embodiments, with continued reference to FIG. 2B, the content item may be video content, and the electronic device 110 may pause or continue to play the video content in the process of moving the image content based on the received interaction operation.

In some embodiments, with continued reference to FIG. 2B, the electronic device 110 may suspend playing the background music or adjust the background music to the mute state in the process of moving the image content based on the received interaction operation.

In some embodiments, with continued reference to FIG. 2B, the electronic device 110 may present at least one interface element in the first interface 200B.

In some embodiments, with continued reference to FIG. 2B, the at least one interface element may include a first interface element 220 associated with the text content of the content item. As an example, as shown in FIG. 2B, the first interface element associated with the text content of the content item may include, for example, a content item name, a content item summary description, an author name, and the like.

In some embodiments, with continued reference to FIG. 2B, the at least one interface element may include a second interface element 225 for interacting with the content item. As an example, the second interface element may include, for example, a set of interaction controls associated with the content item. As an example, the set of interaction controls 225 may include, for example, a like control, a comment control, a favorite control, and/or a forwarding control.

In some embodiments, with continued reference to FIG. 2B, the electronic device 110 may adjust the visibility of the at least one interface element in the first interface based on the received interaction operation without changing the position of the at least one interface element. As an example, the electronic device 110 may adjust the transparency (e.g., decrease transparency) of the first interface element 220 based on the received interaction operation. As an example, the electronic device 110 may cease presenting the second interface element 225 in the first interface 200B based on the received interaction operation (e.g., may be understood as adjusting the second interface element 225 to be invisible).

In some embodiments, with continued reference to FIG. 2B, the electronic device 110 may display the interaction indication element 210 in the first interface 200B before the interaction operation satisfies the first trigger condition. The interaction indication element 210 is used to prompt the interaction operation. The second indication element 210 may prompt the user to continue the interaction operation, such that the interaction operation being maintained until the first trigger condition is satisfied.

In some embodiments, with continued reference to FIG. 2C, in response to the interaction operation being maintained until the first trigger condition is satisfied, the electronic device 110 may cease presenting the interaction indication element 210.

In some embodiments, with continued reference to FIG. 2C, the interaction operation may be a sliding operation, and the interaction indication element 210 may indicate a predetermined sliding direction. As an example, the interaction operation being maintained until the first triggering condition is satisfied may include that the sliding distance of the sliding operation in the sliding direction (e.g., the direction indicated by the first arrow 206) satisfies the first threshold. As an example, the first threshold may be determined by related technologies, and the present disclosure is not intended to limit a specific value of the first threshold.

In some embodiments, as shown in FIG. 2C, in response to the interaction operation being maintained until the first trigger condition is satisfied, the electronic device 110 may display, in the first interface 200C, the interface indication element 215 corresponding to the second interface.

In some embodiments, with continued reference to FIG. 2C, in response to the currently displayed image content 205 in the first interface satisfying the predetermined condition, the electronic device 110 may display, in the first interface 200C, the interface indication element 215 corresponding to the second interface. As an example, as shown in FIG. 2C, the interface indication element 215 may be an indication element corresponding to a detail page of the content item.

In some embodiments, the content item may include a plurality of images, and the predetermined condition includes the currently displayed image content being the last image of the plurality of images. As an example, the predetermined condition satisfied by the currently displayed image content 205 is that the currently displayed image content is the last image content in the content item. As an example, if the currently displayed image content is not the last image content in the content item, the electronic device 110 may move the currently displayed image content based on the received interaction operation, and present the next image content in the content item.

In some embodiments, with continued reference to FIG. 2C, in response to the first trigger condition being satisfied and the second trigger condition not being satisfied, the electronic device 110 may display, in the first interface 200C, the interface indication element 215 corresponding to the second interface in the first style. As an example, as shown in FIG. 2C, the first style corresponding to the interface indication element 215 may, for example, correspond to a background filling of the first color to indicate that the second trigger condition is not satisfied.

In some embodiments, as shown in FIG. 2D, in response to the interaction operation being maintained until the second trigger condition is satisfied, the electronic device 110 may adjust the interface indication element 215 to the second style to indicate that the second trigger condition is satisfied. As an example, the interaction operation being maintained until the second trigger condition is satisfied may include that the sliding distance of the sliding operation in the sliding direction (e.g., the direction indicated by the first arrow 206) satisfies the second threshold. The second threshold is greater than the first threshold, as an example, the second threshold may be determined by related technologies, and the present disclosure is not intended to limit the specific value of the second threshold. As an example, as shown in FIG. 2D, the second style corresponding to the interface indication element 215 may, for example, correspond to a background filling of the second color to indicate that the second trigger condition is satisfied.

In some embodiments, with continued reference to FIG. 2D, the element content of the interface indication element 215 (i.e., the content (e.g., including pattern shape, color, etc.) presented in the first interface 200D of the interface indication element 215) is determined based on the type of the second interface.

In some embodiments, the second interface may include a detail page of the content item, or a profile page of the user associated with the content item.

In some embodiments, as shown in FIG. 2E, in response to the end state of the interaction operation satisfying the second trigger condition, the electronic device 110 may present the transition animation of switching from the first interface 200E to the second interface 200F. As an example, the transition animation may dynamically show the process that the presentation proportion of the first interface 200E in the electronic device 110 decreases, and the presentation proportion of the second interface 200F in the electronic device 110 increases until the second interface 200F is fully presented in the electronic device 110.

In some embodiments, as shown in FIG. 2F, in response to the end state of the interaction operation satisfying the second trigger condition, the electronic device 110 may switch to display the second interface 200F corresponding to the interface indication element. As an example, the second interface 200F may be a detail page of the content item. As an example, the electronic device 110 may provide the image content of the content item in the second interface 200F, as well as detail text content associated with the content item.

In some embodiments, the detail text content may include complete text content, tag content and/or review content of the content item, of the content item. As an example, complete text content of a content item may include a title, author name, content item introduction, etc. of the content item. As an example, the comment content of the content item may include comment content and comment time of other users (other than the author of the content item) that are associated with the content item.

In some embodiments, with continued reference to FIG. 2D, the end state of the interaction operation satisfying the second trigger condition includes: the sliding distance of the sliding operation in the sliding direction satisfies a third threshold, and the third threshold is greater than the first threshold. As an example, the third threshold may be greater than or equal to the second threshold. The present disclosure is not intended to limit the specific value of the third threshold.

In some embodiments, with continued reference to FIG. 2D, in response to the end state of the interaction operation failing to satisfy the second trigger condition, the electronic device 110 may move the image content 205 to a predetermined position (for example, the original display position of the image content 205 in FIG. 2A) in the first interface 200D.

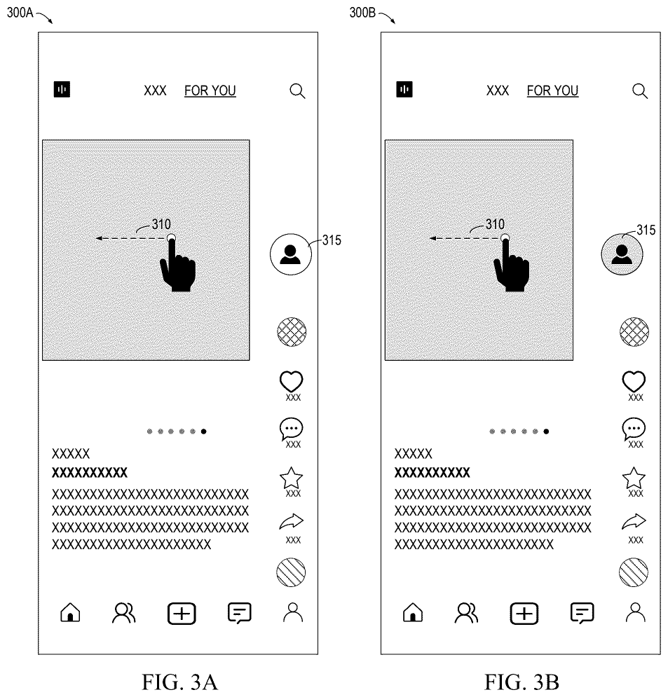

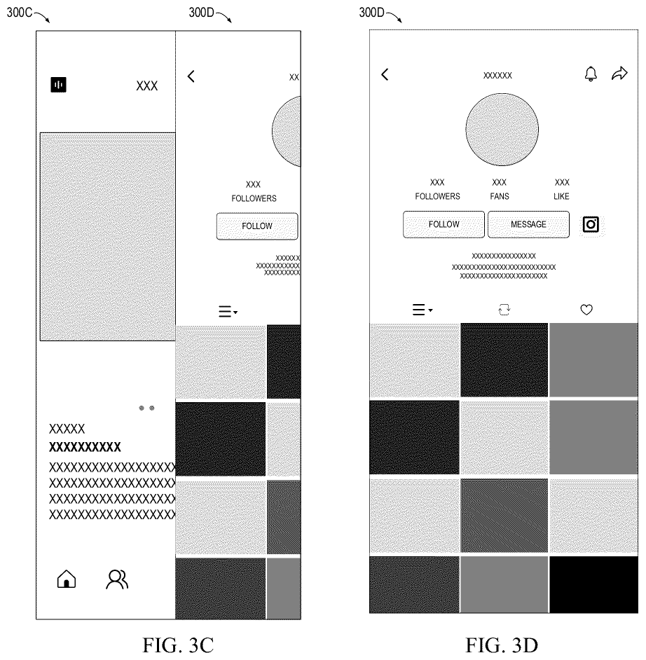

FIGS. 3A-3D illustrate example interfaces 300A-300D, in accordance with some embodiments of the present disclosure. The interface 300A to the interface 300D may be provided, for example, by the electronic device 110 shown in FIG. 1.

In some embodiments, as shown in FIG. 3A, the electronic device 110 may present the third interface 300A through the content item data downloaded from the server. As an example, the third interface 300A may be a play page of a content item, and a play page of the content item may display the image content of the content item.

In some embodiments, with continued reference to FIG. 3A, in response to the interaction operation being maintained until the first trigger condition is satisfied and the second trigger condition is not satisfied, the electronic device 110 may display, in the third interface 300A, the second interface indication element 315 corresponding to the fourth interface in the third style. In some embodiments, as shown in FIG. 3A, the fourth interface may be a profile presentation page of a user associated with the content item, and the fourth interface indication element 315 may be an indication element corresponding to the profile presentation page. As an example, as shown in FIG. 3A, the background in the third style corresponding to the second interface indication element 315 may be a white background. As an example, the interaction operation being maintained until the first trigger condition is satisfied may include that the sliding distance of the sliding operation in the sliding direction (e.g., the direction indicated by the second arrow 310) satisfies the fourth threshold. The present disclosure is not intended to limit the specific value of the fourth threshold.

In some embodiments, as shown in FIG. 3B, in response to the interaction operation being maintained until the second trigger condition is satisfied, the electronic device 110 may display, in the third interface 300B, the second interface indication element 315 corresponding to the fourth interface in a fourth style. As an example, as shown in FIG. 3B, the background in the fourth style corresponding to the second interface indication element 315 may be a non-white background. As an example, the interaction operation being maintained until the second trigger condition is satisfied may include that the sliding distance of the sliding operation in the sliding direction (e.g., the direction indicated by the second arrow 310) satisfies the fifth threshold. The fifth threshold is greater than the fourth threshold. The present disclosure is not intended to limit the specific value of the fifth threshold.

In some embodiments, as shown in FIG. 3C, in response to the end state of the interaction operation satisfying the second trigger condition, the electronic device 110 may present the transition animation of switching the third interface 300C to the fourth interface 300D. As an example, the transition animation may dynamically show the process that the presentation proportion of the third interface 300C in the electronic device 110 decreases, and the presentation proportion of the fourth interface 300D in the electronic device 110 increases until the fourth interface 300D is fully presented in the electronic device 110.

In some embodiments, as shown in FIG. 3D, in response to the end state of the interaction operation satisfying the second trigger condition, the electronic device 110 may switch to displaying the fourth interface 300D corresponding to the interface indication element. As an example, the fourth interface 300D may be a profile page of a user associated with the content item. As an example, the electronic device 110 may provide, in the fourth interface 300D, personal introduction information, a plurality of content items, and other related information of a user associated with the content item.

Based on the foregoing process, embodiments of the present disclosure can present, after receiving the interaction operation of the user, an interface indication element corresponding to the detail page or the profile presentation page associated with the content item based on the interaction operation. Further, the interface indication element may prompt the user to switch from the play page of the content item to the detail page or the profile presentation page, and adjust the display style of the text content and/or the interaction component based on the interaction operation, so as to enhance the prompting effect and prevent the incorrect operation of the user.

In this way, the present disclosure can provide more information elements for the user during the interaction operation, thereby improving the utilization rate of the information elements. Therefore, by providing the information element, the user can perceive that the interface can be switched to the corresponding interface based on the interaction operation, thereby improving the accuracy of interface switching and avoiding the occurrence of incorrect operation. In addition, the presentation efficiency of the detail page of the content item or the profile page of the user and the interaction experience of the user can be improved.

### Example Processes

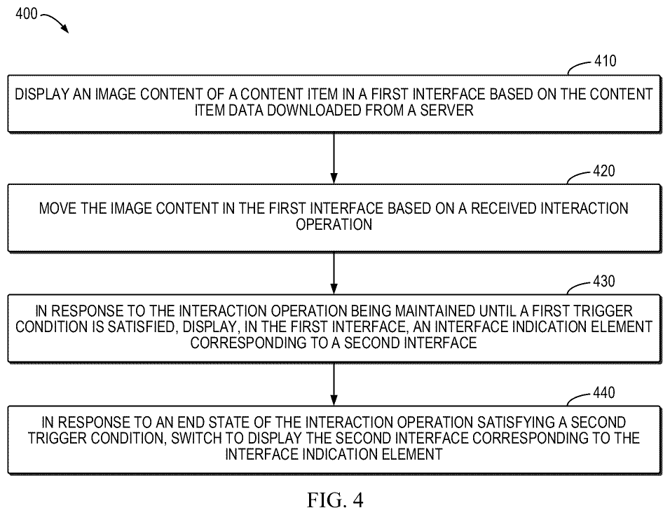

FIG. 4 illustrates a flowchart of an example process 400 of interface interaction in accordance with some embodiments of the present disclosure. Process 400 may be implemented at electronic device 110. The process 400 is described below with reference to FIG. 1.

As shown, at block 410, the electronic device 110 displays an image content of a content item in a first interface.

At block 420, the electronic device 110 moves the image content in the first interface based on a received interaction operation.

In block 430, the electronic device 110, in response to the interaction operation being maintained until a first trigger condition is satisfied, displaying, in the first interface, an interface indication element corresponding to a second interface.

In block 440, the electronic device 110, in response to an end state of the interaction operation satisfying a second trigger condition, switching to display the second interface corresponding to the interface indication element.

In some embodiments, displaying, in the first interface, the interface indication element corresponding to the second interface comprises: in response to the image content currently displayed in the first interface satisfying a predetermined condition, displaying, in the first interface, the interface indication element corresponding to the second interface.

In some embodiments, the content item comprises a plurality of images, and the predetermined condition comprises the currently displayed image content being a last image of the plurality of images.

In some embodiments, the method 400 further includes: displaying, in the first interface, an interaction indication element for prompting the interaction operation before the interaction operation satisfies the first trigger condition.

In some embodiments, the interaction operation comprises a sliding operation, and the interaction indication element indicates a predetermined sliding direction.

In some embodiments, the method 400 further includes: in response to the interaction operation being maintained until the first trigger condition is satisfied, ceasing to display the interaction indication element.

In some embodiments, displaying, in the first interface, the interface indication element corresponding to the second interface comprises: in response to the first trigger condition being satisfied and the second trigger condition failing to be satisfied, displaying the interface indication element in a first style in the first interface; and in response to the interaction operation being maintained until the second trigger condition is satisfied, adjusting the interface indication element to a second style to indicate that the second trigger condition is satisfied.

In some embodiments, the method 400 further includes: adjusting a visibility of at least one interface element in the first interface based on the interaction operation without changing a position of the at least one interface element.

In some embodiments, the at least one interface element comprises: a first interface element associated with a text content of the content item; a second interface element for interacting with the content item.

In some embodiments, an element content of the interface indication element is determined based on a type of the second interface.

In some embodiments, the second interface comprises: a detail page of the content item, or a profile page of a user associated with the content item.

In some embodiments, the method 400 further comprises: in response to the end state of the interaction operation failing to satisfy the second trigger condition, moving the image content to a predetermined position in the first interface.

### Example Apparatus and Apparatus

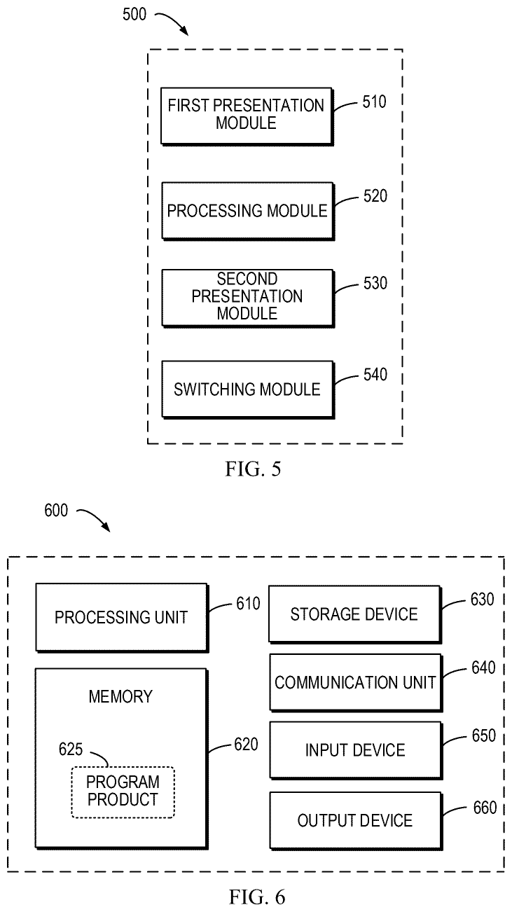

Embodiments of the present disclosure also provide a corresponding apparatus for implementing the above method or process. FIG. 5 shows a schematic structural block diagram of an example apparatus 500 for interface interaction according to some embodiments of the present disclosure. The apparatus 500 may be implemented or included in an electronic device. The various modules/components in the apparatus 500 may be implemented by hardware, software, firmware, or any combination thereof.

As shown in FIG. 5, the apparatus 500 includes a first presentation module 510 configured to display an image content of a content item in a first interface; a processing module 520 configured to move the image content in the first interface based on a received interaction operation; a second presentation module 530 configured to, in response to the interaction operation being maintained until a first trigger condition is satisfied, display, in the first interface, an interface indication element corresponding to a second interface; and a switching module 540 configured to, in response to an end state of the interaction operation satisfying a second trigger condition, switch to display the second interface corresponding to the interface indication element.

In some embodiments, the second presentation module 530 is further configured to: in response to the image content currently displayed in the first interface satisfying a predetermined condition, display, in the first interface, the interface indication element corresponding to the second interface.

In some embodiments, the content item comprises a plurality of images, and the predetermined condition comprises the currently displayed image content being a last image of the plurality of images.

In some embodiments, the apparatus 500 further includes a third presentation module configured to: displaying, in the first interface, an interaction indication element for prompting the interaction operation before the interaction operation satisfies the first trigger condition.

In some embodiments, the interaction operation comprises a sliding operation, and the second presentation module 530 is further configured that: the interaction indication element indicates a predetermined sliding direction.

In some embodiments, the apparatus 500 further includes a ceasing module configured to: in response to the interaction operation being maintained until the first trigger condition is satisfied, cease to display the interaction indication element.

In some embodiments, the second presentation module 530 is further configured to: in response to the first trigger condition being satisfied and the second trigger condition failing to be satisfied, display the interface indication element in a first style in the first interface; and in response to the interaction operation being maintained until the second trigger condition is satisfied, adjust the interface indication element to a second style to indicate that the second trigger condition is satisfied.

In some embodiments, the apparatus 500 further includes an adjustment module configured to: adjust a visibility of at least one interface element in the first interface based on the interaction operation without changing a position of the at least one interface element.

In some embodiments, the at least one interface element comprises: a first interface element associated with a text content of the content item; and a second interface element for interacting with the content item.

In some embodiments, an element content of the interface indication element is determined based on a type of the second interface.

In some embodiments, the second interface comprises: a detail page of the content item, or a profile page of a user associated with the content item.

In some embodiments, the apparatus 500 further comprises a movement module, configured to: in response to the end state of the interaction operation failing to satisfy the second trigger condition, move the image content to a predetermined position in the first interface.

FIG. 6 illustrates a block diagram of an electronic device 600 in which one or more embodiments of the present disclosure may be implemented. It should be understood that the electronic device 600 illustrated in FIG. 6 is merely exemplary and should not constitute any limitation on the functionality and scope of the embodiments described herein. The electronic device 600 shown in FIG. 6 may be used in an electronic device.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

I/We claim:

1. A method of interface interaction, comprising:
displaying an image content of a content item in a first interface;
moving the image content in the first interface based on a received interaction operation;
in response to the interaction operation being maintained until a first trigger condition is satisfied, displaying, in the first interface, an interface indication element corresponding to a second interface; and
in response to an end state of the interaction operation satisfying a second trigger condition, switching to display the second interface corresponding to the interface indication element.

2. The method of claim 1, wherein displaying, in the first interface, the interface indication element corresponding to the second interface comprises:
in response to the image content currently displayed in the first interface satisfying a predetermined condition, displaying, in the first interface, the interface indication element corresponding to the second interface.

3. The method of claim 2, wherein the content item comprises a plurality of images, and the predetermined condition comprises the currently displayed image content being a last image of the plurality of images.

4. The method of claim 1, further comprising:
before the interaction operation satisfies the first trigger condition, displaying, in the first interface, an interaction indication element for prompting the interaction operation.

5. The method of claim 4, wherein the interaction operation comprises a sliding operation, and the interaction indication element indicates a predetermined sliding direction.

6. The method of claim 3, further comprising:
in response to the interaction operation being maintained until the first trigger condition is satisfied, ceasing to display the interaction indication element.

7. The method of claim 1, wherein displaying, in the first interface, the interface indication element corresponding to the second interface comprises:
in response to the first trigger condition being satisfied and the second trigger condition failing to be satisfied, displaying the interface indication element in a first style in the first interface; and
in response to the interaction operation being maintained until the second trigger condition is satisfied, adjusting the interface indication element to a second style to indicate that the second trigger condition is satisfied.

8. The method of claim 1, further comprising:
adjusting a visibility of at least one interface element in the first interface based on the interaction operation without changing a position of the at least one interface element.

9. The method of claim 8, wherein the at least one interface element comprises:
a first interface element associated with a text content of the content item; and
a second interface element for interacting with the content item.

10. The method of claim 1, wherein an element content of the interface indication element is determined based on a type of the second interface.

11. The method of claim 10, wherein the second interface comprises:
a detail page of the content item, or
a profile page of a user associated with the content item.

12. The method of claim 1, further comprising:
in response to the end state of the interaction operation failing to satisfy the second trigger condition, moving the image content to a predetermined position in the first interface.

13. An electronic device, comprising:
at least one processing unit; and
at least one memory coupled to the at least one processing unit and storing instructions for execution by the at least one processing unit, the instructions, when executed by the at least one processing unit, cause the electronic device to perform a method of interface interaction, comprising:
displaying an image content of a content item in a first interface;
moving the image content in the first interface based on a received interaction operation;
in response to the interaction operation being maintained until a first trigger condition is satisfied, displaying, in the first interface, an interface indication element corresponding to a second interface; and
in response to an end state of the interaction operation satisfying a second trigger condition, switching to display the second interface corresponding to the interface indication element.

14. The electronic device of claim 13, wherein displaying, in the first interface, the interface indication element corresponding to the second interface comprises:
in response to the image content currently displayed in the first interface satisfying a predetermined condition, displaying, in the first interface, the interface indication element corresponding to the second interface.

15. The electronic device of claim 14, wherein the content item comprises a plurality of images, and the predetermined condition comprises the currently displayed image content being a last image of the plurality of images.

16. The electronic device of claim 13, wherein the method further comprises:
before the interaction operation satisfies the first trigger condition, displaying, in the first interface, an interaction indication element for prompting the interaction operation.

17. The electronic device of claim 16, wherein the interaction operation comprises a sliding operation, and the interaction indication element indicates a predetermined sliding direction.

18. The electronic device of claim 15, wherein the method further comprises:
in response to the interaction operation being maintained until the first trigger condition is satisfied, ceasing to display the interaction indication element.

19. The electronic device of claim 13, wherein displaying, in the first interface, the interface indication element corresponding to the second interface comprises:
in response to the first trigger condition being satisfied and the second trigger condition failing to be satisfied, displaying the interface indication element in a first style in the first interface; and
in response to the interaction operation being maintained until the second trigger condition is satisfied, adjusting the interface indication element to a second style to indicate that the second trigger condition is satisfied.

20. A computer-readable storage medium storing a computer program thereon, the computer program, when executable by a processor, implements a method of interface interaction, comprising:
displaying an image content of a content item in a first interface;
moving the image content in the first interface based on a received interaction operation;
in response to the interaction operation being maintained until a first trigger condition is satisfied, displaying, in the first interface, an interface indication element corresponding to a second interface; and
in response to an end state of the interaction operation satisfying a second trigger condition, switching to display the second interface corresponding to the interface indication element.
